(19) United States
(12) Patent Application Publication
(10) Pub. No.: US 2012/0098741 A1
(43) Pub. Date: Apr. 26, 2012

(54) ELECTROPHORETIC DISPLAY WITH INTEGRATED TOUCH SCREEN

(75) Inventors: Tae-Whan Kim, Seoul (KR); Su-Hyeong Park, Gyeongju-si Gyeongsangbuk-do (KR); Dea-Uk Lee, Goyang-si Gyeonggi-do (KR)

(73) Assignee: INDUSTRY-UNIVERSITY COOPERATION FOUNDATION, HANYANG UNIVERSITY, Seoul (KR)

(21) Appl. No.: 13/379,234

(22) PCT Filed: Jun. 17, 2010
(86) PCT No.: PCT/KR2010/003899

§ 371 Date: Dec. 19, 2011

(30) Foreign Application Priority Data
Jun. 17, 2009 (KR) 10-2009-0053896
Jul. 14, 2009 (KR) 10-2009-0064228

(51) Int. Cl. G09G 3/34

(52) U.S. Cl. 345/107

(57) ABSTRACT

An electrophoretic display includes a substrate on which image gate lines and image signal lines are formed to intersect one another. An image switching thin-film transistor (TFT) is formed on the substrate and electrically connected to the image gate lines and the image signal lines. A sensing TFT is formed on the substrate and configured to sense infrared (IR) light and generate an IR sensing signal. An output switching TFT is formed on the substrate and connected to the sensing TFT. The output switching TFT outputs position information from the IR sensing signal. An IR filter insulating layer is formed on the substrate to cover the sensing TFT and configured to transmit only the IR light. A pixel electrode is formed on the IR filter insulating layer and electrically connected to the image switching TFT. An electrophoretic film is formed on the pixel electrode and includes a plurality of micro-capsules having pigment particles with positive and negative electrical charges. A common electrode is formed on the electrophoretic film.

### CROSS-REFERENCE TO RELATED APPLICATIONS

This application claims priority to and the benefit of Korean Patent Applications No. 10-2009-0053896 and 10-2009-0064228, filed on Jun. 17, 2009 and Jul. 14, 2009, respectively, the disclosures of which are incorporated herein by references in their entirety.

### BACKGROUND

1. Field of the Invention

The present invention relates to an electrophoretic display device, and more particularly, to an electrophoretic display device having a touch sensing function.

2. Discussion of Related Art

In general, a display device is a device configured to receive an image signal and display an image. Display devices may include, for example, a cathode-ray tube (CRT) display device, a liquid crystal display (LCD) device, and an electrophoretic display device.

A CRT display device may include a vacuum tube and allow an electronic gun to emit electronic beams to display an image. The CRT display device may be thick and heavyweight because a sufficient distance within which electronic beams may rotate should be ensured. An LCD device may display an image using optical characteristics of liquid crystals and be thinner and more lightweight than a CRT display device. However, since the LCD device should include a backlight assembly configured to provide light to the liquid crystals, there is a specific technical limit to making the LCD device thin and lightweight.

An electrophoretic display device may display an image using a phenomenon that charged pigment particles migrate due to an electrical field generated between upper and lower substrates (i.e., electrophoresis). The electrophoretic display device does not need an additional light source because the electrophoretic display device is a reflective display configured to display an image using external light. Accordingly, the electrophoretic display device is thinner and more lightweight than an LCD device.

However, a conventional electrophoretic display device has only a display function and is incapable of a user interface function which is adhered onto a display device and senses a touch point to be contacted by a finger or a pen based on changed electrical properties.

### SUMMARY OF THE INVENTION

The present invention is directed to providing an electrophoretic display device with an integrated touch screen using an infrared (IR) optical sensor technique.

According to an aspect of the present invention, there is provided an electrophoretic display device including: a substrate on which image gate lines and image signal lines are formed to intersect one another, an image switching thin-film transistor (TFT) formed on the substrate and electrically connected to the image gate lines and the image signal lines, a sensing TFT formed on the substrate and configured to sense IR light and generate an IR sensing signal, an output switching TFT formed on the substrate and connected to the sensing TFT, the output switching TFT configured to output position information from the IR sensing signal, an IR filter insulating layer formed on the substrate to cover the sensing TFT and configured to transmit only the IR light, a pixel electrode formed on the IR filter insulating layer and electrically connected to the image switching TFT, an electrophoretic film formed on the pixel electrode and including a plurality of micro-capsules having pigment particles with positive and negative electrical charges, and a common electrode formed on the electrophoretic film.

According to another aspect of the present invention, there is provided an electrophoretic display device including: a substrate on which image gate lines and image signal lines are formed to intersect one another, an image switching thin-film transistor (TFT) formed on the substrate and electrically connected to the image gate lines and the image signal lines, a sensing TFT formed on the substrate and configured to sense IR light and generate an IR sensing signal, an output switching TFT formed on the substrate and connected to the sensing TFT, the output switching TFT configured to output position information from the IR sensing signal, an insulating layer formed on the substrate to cover the image switching TFT, the sensing TFT, and the output switching TFT, an IR filter formed as a single layer on the insulating layer and configured to transmit only the IR light, a pixel electrode formed on the IR filter and electrically connected to the image switching TFT, an electrophoretic film formed on the pixel electrode and including a plurality of micro-capsules having pigment particles with positive and negative electrical charges, and a common electrode formed on the electrophoretic film.

According to another aspect of the present invention, there is provided, an electrophoretic display device including: a substrate on which image gate lines and image signal lines intersect one another, an image switching TFT formed on the substrate and electrically connected to the image gate lines and the image signal lines, a sensing TFT formed on the substrate and configured to sense IR light and generate an IR sensing signal, an output switching TFT formed on the substrate and connected to the sensing TFT, the output switching TFT configured to output position information from to the IR sensing signal, an insulating layer formed on the substrate to cover the image switching TFT, the sensing TFT, and the output switching TFT, a pixel electrode formed on the insulating layer and electrically connected to the image switching TFT, an IR filter formed as a single layer on the pixel electrode and configured to transmit only the IR light, an electrophoretic film formed on the IR filter and including a plurality of micro-capsules having pigment particles with positive and negative electrical charges, and a common electrode formed on the electrophoretic film.

A channel region of the sensing TFT may be formed of a material capable of absorbing light having an IR wavelength. For example, a channel region of each of the image switching TFT and the output switching TFT may be formed of amorphous silicon (a-Si), and a channel region of the sensing TFT may be formed of polycrystalline silicon (poly-Si).

The IR filter insulating layer may include first insulating layers having a relatively high refractive index and second insulating layers having a relatively low refractive index formed in an alternating fashion. In this case, the first insulating layers may be formed of at least one selected from the group consisting of titanium oxide (TiO₂), tantalum oxide (Ta₂O₅), zirconium oxide (ZrO₂), and zinc sulfide (ZnS), and the second insulating layers may be formed of at least one selected from the group consisting of silicon oxide (SiO₂), magnesium fluoride (MgF₂), and sodium aluminum iron (Na₃AlFe).

The IR filter may include at least one selected from the group consisting of chromium oxides (CrO and Cr₂O₃) and manganese oxides (MnO, Mn₃O₄, Mn₂O₃, MnO₂, and Mn₂O₇).

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic construction diagram of an electrophoretic display device according to a first exemplary embodiment of the present invention;

FIG. 2 is a schematic construction diagram of an electrophoretic display device according to a second exemplary embodiment of the present invention;

FIG. 3 is a schematic construction diagram of an electrophoretic display device according to a third exemplary embodiment of the present invention;

FIG. 4 is a schematic construction diagram of an electrophoretic display device according to a fourth exemplary embodiment of the present invention; and

FIG. 5 is a circuit diagram of an image displaying process and a sensing process of an electrophoretic display device according to an exemplary embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

The present invention will be described more fully hereinafter with reference to the accompanying drawings, in which exemplary embodiments of the invention are shown. This invention may, however, be embodied in different forms and should not be construed as limited to the embodiments set forth herein. Rather, these embodiments are provided so that this disclosure is thorough and complete and fully conveys the scope of the invention to one skilled in the art. Like numbers refer to like element in the drawings.

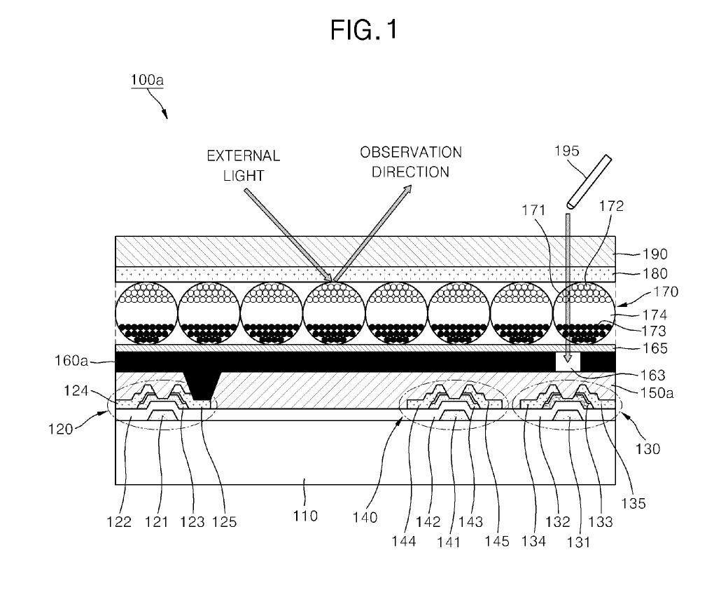

FIG. 1 is a schematic construction diagram of an electrophoretic display device according to a first exemplary embodiment of the present invention.

Referring to FIG. 1, an electrophoretic display device 100a according to the first exemplary embodiment of the present invention may include a substrate 110, an image switching thin-film transistor (TFT) 120, a sensing TFT 130, an output switching TFT 140, an infrared (IR) filter insulating layer 150a, a pixel electrode 160a, an adhesive 165, an electrophoretic film 170, a common electrode 180, and an upper plate 190.

The substrate 110 may be formed of a material having an insulation characteristic and a high melting point or a material having flexibility and an insulation characteristic. When the substrate 110 is formed of a material having an insulation characteristic and a high melting point, a glass substrate, a sapphire substrate, or a quartz substrate may be used or a metal plate including an insulating layer or a silicon (Si), gallium arsenide (GaAs), or indium phosphide (InP) substrate including an insulating layer may be used. When the substrate 110 is formed of a material having flexibility and an insulation characteristic, a plastic substrate, such as a polyethylene terephthalate (PET) substrate, a polycarbonate (PC) substrate, or an AryLite substrate, may be used or a very thin Si, GaAs, or InP substrate having an insulating layer or a metal foil having an insulating layer may be used. Image gate lines (not shown) and image signal lines (not shown) may be formed on the substrate 110 to intersect one another. Cell regions may be defined by intersections of the image gate lines and the image signal lines.

The image switching TFT 120 may be formed on the substrate 110 and include an image switching gate electrode 121, an image switching gate insulating layer 122, an image switching channel region 123, an image switching source region 124, and an image switching drain region 125. The image switching gate electrode 121 may be formed of a conductive material and electrically connected to an image gate line. The image switching gate insulating layer 122 may be formed of an insulating material to cover the image switching gate electrode 121. The image switching channel region 123 may be formed on the image switching gate insulating layer 122 and formed of amorphous silicon (a-Si) or polycrystalline silicon (poly-Si). Each of the image switching source region 124 and the image switching drain region 125 may be formed to cover a portion of the image switching channel region 123 on the reverse side of the image switching gate electrode 121. The image switching source region 124 may be electrically connected to the image signal lines, while the image switching drain region 125 may be electrically connected to the pixel electrode 160a, and thereby an image signal voltage having high and low levels can be applied to the pixel electrode 160a.

The sensing TFT 130 may be formed on the substrate 110, sense IR light, and generate an IR sensing signal. The sensing TFT 130 may include a sensing gate electrode 131, a sensing gate insulating layer 132, a sensing channel region 133, a sensing source region 134, and a sensing drain region 135. The sensing gate electrode 131 may be formed of a conductive material and electrically connected to an off-voltage line (not shown). The sensing gate insulating layer 132 may be formed of an insulating material and cover the sensing gate electrode 131. The sensing channel region 133 may be formed on the sensing gate insulating layer 132 and formed of a material capable of absorbing light having an IR wavelength. To this end, the sensing channel region 133 may be formed of poly-Si, single crystalline Si, indium antimony (InSb), germanium (Ge), indium arsenide (InAs), indium gallium arsenide (InGaAs), cadmium telluride (CdTe), cadmium selenide (CdSe), gallium arsenide (GaAs), gallium indium phosphide (GaInP), indium phosphide (InP), aluminum gallium arsenide (AlGaAs), or a combination thereof. Each of the sensing source region 134 and the sensing drain region 135 may be formed to cover a portion of the sensing channel region 133 on the reverse side of the sensing gate electrode 131. The sensing source region 134 may be electrically connected to a power supply line (not shown), while the sensing drain region 135 may be electrically connected to a storage capacitor (not shown) for storing an IR sensing signal. When the channel region 133 of the sensing TFT 130 absorbs IR light, the storage capacitor for storing the IR sensing signal may be charged with electrical charges of a leakage current increased due to the absorption of the IR light.

The output switching TFT 140 may be formed on the substrate 110 and include an output switching gate electrode 141, an output switching gate insulating layer 142, an output switching channel region 143, an output switching source region 144, and an output switching drain region 145. The output switching gate electrode 141 may be formed of a conductive material and electrically connected to a sensing gate line (not shown). The output switching gate insulating layer 142 may be formed of an insulating material to cover the output switching gate electrode 141. The output switching channel region 143 may be formed on the output switching gate insulating layer 142 and formed of a-Si or poly-Si. Each of the output switching source region 144 and the output switching drain region 145 may be formed to cover a portion of the output switching channel region 143 on the reverse side of the output switching gate electrode 141. The output switching source region 144 may be electrically connected to the storage capacitor for storing an IR sensing signal, while the output switching drain region 145 may be electrically connected to an output line (not shown). That is, the output switching TFT 140 may be electrically connected to the sensing TFT 130 through the storage capacitor for storing the IR sensing signal and output position information from the IR sensing signal generated by the sensing TFT 130.

The gate insulating layers 122, 132, and 142 respectively included in the image switching TFT 120, the sensing TFT 130, and the output switching TFT 140 may be integrally formed as shown in FIG. 1. After all the channel regions 123, 133, and 143 respectively included in the image switching TFT 120, the sensing TFT 130, and the output switching TFT 140 are formed of a-Si, only the channel region 133 of the sensing TFT 130 may be crystallized into poly-Si. The crystallization of the channel region 133 of the sensing TFT 130 may be performed using a low-temperature polycrystalline silicon (LTPS) process when the substrate 110 is a glass substrate, and be performed using a high-temperature polycrystalline silicon (HTPS) process when the substrate 110 is capable of a high-temperature process. Since the LTPS and HTPS processes are known to those skilled in the art, a detailed description thereof will not be presented here.

The IR filter insulating layer 150a may transmit only IR light without transmitting light having a wavelength other than an IR wavelength. The IR filter insulating layer 150a may be formed on the substrate 110 to cover the image switching TFT 120, the sensing TFT 130, and the output switching TFT 140. Since the electrophoretic display device 100a according to the present invention has a reflective structure, the IR filter insulating layer 150a may not be formed of a transparent organic material unlike conventional liquid crystal display (LCD) devices. The IR filter insulating layer 150a may have a multilayered thin structure including first insulating layers having a relatively high refractive index and second insulating layers having a relatively low refractive index formed in an alternating fashion. In this case, the first insulating layers may be formed of titanium oxide (TiO₂), tantalum oxide (Ta₂O₅), zirconium oxide (ZrO₂), zinc sulfide (ZnS), or a combination thereof, and the second insulating layers may be formed of silicon oxide (SiO₂), magnesium fluoride (MgF₂), sodium aluminum iron (Na₃AlFe), or a combination thereof.

The pixel electrode 160a may be formed in a unit pixel region on the IR filter insulating layer 150a. Also, a contact hole exposing a portion of the image switching drain region 125 of the image switching TFT 120 may be formed in the IR filter insulating layer 150a. The pixel electrode 160a may extend into the contact hole and be electrically connected to the image switching drain region 125 of the image switching TFT 120. Thus, the image switching TFT 120 may switch a pixel voltage to the pixel electrode 160a. The pixel electrode 160a may be formed of a light reflective material so that the pixel electrode 160a may serve as a light blocking layer with respect to the image switching TFT 120 and the output switching TFT 140. Also, a through hole 163 may be formed through top and bottom surfaces of the pixel electrode 160a so that IR light may be incident to the sensing TFT 130. The through hole 163 may be disposed over the sensing TFT 130.

The upper plate 190 may be disposed opposite the substrate 110 to face the pixel electrode 160a. The upper plate 190 may be formed of a flexible plastic, an easily bendable base film, or a flexible metal. For example, the upper plate 190 may be formed of PET.

The common electrode 180 may be formed on a bottom surface of the upper plate 190 and formed of a transparent conductive material that transmits light. To this end, the common electrode 180 may be formed of indium tin oxide (ITO), Al-doped zinc oxide (AZO), indium zinc oxide (IZO), carbon nanotubes, graphene, or a combination thereof.

The electrophoretic film 170 may be formed on a bottom surface of the common electrode 180 and include a plurality of micro-capsules 171. The micro-capsules 171 may have ball shapes with a size of about several hundred μm and include pigment particles 172 with positive electrical charges and pigment particles 173 with negative electrical charges. The pigment particles 172 with the positive electrical charges and the pigment particles 173 with the negative electrical charges may be mixed with a transparent fluid 174. The pigment particles 172 and 173 may be respectively separated from one another along a direction of an electric field between the common electrode 190 and the pixel electrode 160a. Since the pigment particles 172 and 173 exhibit bistable characteristics, even if the electric fields is lost, the pigment particles 172 and 173 may remain in the present states.

The pigment particles 172 with the positive electrical charges and the pigment particles 173 with the negative electrical charges may display black and white or other colors. When the pigment particles 172 with the positive electrical charges and the pigment particles 173 with the negative electrical charges display black and white, as shown in FIG. 1, the pigment particles 172 with the positive electrical charges may be embodied by white pigment particles, while the pigment particles 173 with the negative electrical charges may be embodied by black pigment particles. In this case, when the black pigment particles 173 are separated toward the common electrode 190, external light incident through the common electrode 190 may be reflected by the electrophoretic film 170 and embody black. Also, when the white pigment particles 172 are separated toward the common electrode 190, external light incident through the common electrode 190 may be reflected by the electrophoretic film 170 and embody white.

A protection layer (not shown) may be formed on both lateral surfaces of the electrophoretic film 170 to cut off the flow of the micro-capsules 171 and protect the micro-capsules 171.

The adhesive 165 may be adhered to a bottom surface of the electrophoretic film 170 and bond the pixel electrode 160a and the electrophoretic film 170 through a lamination process.

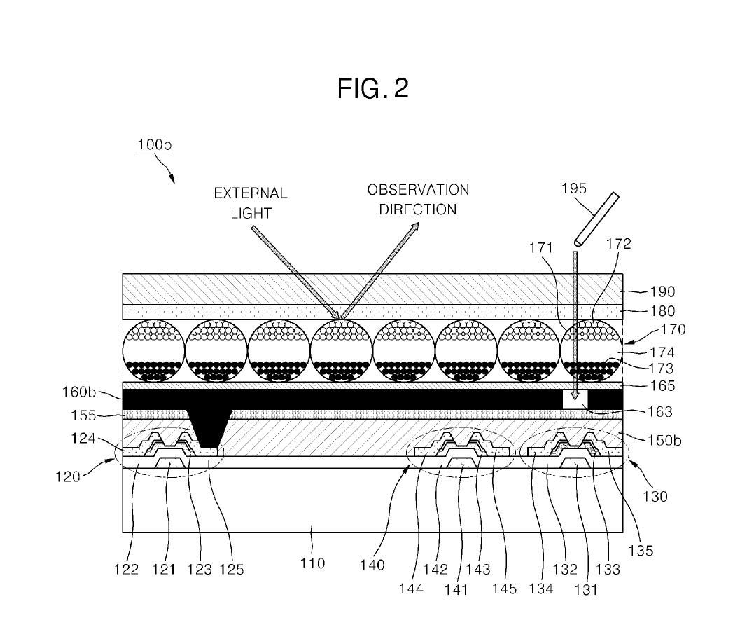

FIG. 2 is a schematic construction diagram of an electrophoretic display device according to a second exemplary embodiment of the present invention.

Referring to FIG. 2, an electrophoretic display device 100b according to the second exemplary embodiment of the present invention may include a substrate 110, an image switching TFT 120, a sensing TFT 130, an output switching TFT 140, an insulating layer 150b, an IR filter 155, a pixel electrode 160b, an adhesive 165, an electrophoretic film 170, a common electrode 180, and an upper plate 190.

The substrate 110, the image switching TFT 120, the sensing TFT 130, the output switching TFT 140, the adhesive 165, the electrophoretic film 170, the common electrode 180, and the upper plate 190 included in the electrophoretic display device 100b according to the second exemplary embodiment may respectively correspond to the substrate 110, the image switching TFT 120, the sensing TFT 130, the output switching TFT 140, the adhesive 165, the electrophoretic film 170, the common electrode 180, and the upper plate 190 included in the electrophoretic display device 100a according to the first exemplary embodiment.

The insulating layer 150b may be formed on the substrate 110 and cover the image switching TFT 120, the sensing TFT 130, and the output switching TFT 140. Since the electrophoretic display device 100b according to the second embodiment has a reflective structure, the insulating layer 150b may not be formed of a transparent organic material unlike conventional LCD devices.

The IR filter 155 may transmit only IR light without transmitting light having a wavelength other than an IR wavelength. The IR filter 155 may be formed as a single layer on the insulating layer 150b. The IR filter 155 may be a single thin layer formed of at least one selected from the group consisting of chromium oxides (CrO and Cr₂O₃) and manganese oxides (MnO, Mn₃O₄, Mn₂O₃, MnO₂, and Mn₂O₇). When the IR filter 155 is embodied by a single thin layer, a forming process may be simplified more than when the IR filter 155 is embodied by a composite layer.

The pixel electrode 160b may be formed in a unit pixel region on the IR filter 155. Also, a contact hole exposing a portion of an image switching drain region 125 of the image switching TFT 120 may be formed in the insulating layer 150a and the IR filter 155. The pixel electrode 160b may extend into the contact hole and be electrically connected to the image switching drain region 125 of the image switching TFT 120. Thus, the image switching TFT 120 may switch a pixel voltage to the pixel electrode 160b. The pixel electrode 160b may be formed of a light reflective material so that the pixel electrode 160b may serve as a light blocking layer with respect to the image switching TFT 120 and the output switching TFT 140. Also, a through hole 163 may be formed through top and bottom surfaces of the pixel electrode 160b so that IR light may be incident to the sensing TFT 130. The through hole 163 may be disposed over the sensing TFT 130.

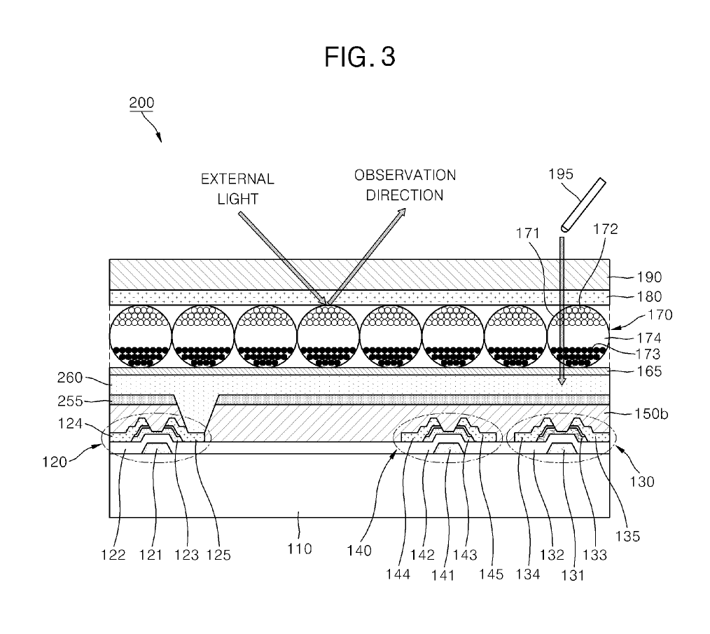

FIG. 3 is a schematic construction diagram of an electrophoretic display device according to a third exemplary embodiment of the present invention.

Referring to FIG. 3, an electrophoretic display device 200 according to a third exemplary embodiment of the present invention may include a substrate 110, an image switching TFT 120, a sensing TFT 130, an output switching TFT 140, an insulating layer 150b, an IR filter 255, a pixel electrode 260, an adhesive 165, an electrophoretic film 170, a common electrode 180, and an upper plate 190.

The substrate 110, the image switching TFT 120, the sensing TFT 130, the output switching TFT 140, the insulating layer 150b, the IR filter 255, the pixel electrode 260, the adhesive 165, the electrophoretic film 170, the common electrode 180, and the upper plate 190 included in the electrophoretic display device 200 according to the third exemplary embodiment may respectively correspond to the substrate 110, the image switching TFT 120, the sensing TFT 130, the output switching TFT 140, the insulating layer 150b, the IR filter 155, the pixel electrode 160b, the adhesive 165, the electrophoretic film 170, the common electrode 180, and the upper plate 190 included in the electrophoretic display device 100b according to the second exemplary embodiment.

However, the pixel electrode 260 according to the third embodiment may be formed not of a light blocking material but of a light transmitting material. That is, the pixel electrode 260 may be formed of at least one selected from the group consisting of ITO, AZO, IZO, carbon nanotubes, and graphene. This is due to the fact that a transparent electrode may be formed on the IR filter 255 because the IR filter 225 includes a single thin layer instead of a composite layer formed using constructive interference and destructive interference.

Since the pixel electrode 260 is formed of a transparent material, it is unnecessary to form an additional through hole in the pixel electrode 260 according to the third exemplary embodiment unlike in the second exemplary embodiment. However, since the pixel electrode 260 is formed of a transparent material, the image switching TFT 120 and the output switching TFT 140 may also be exposed to IR light in addition to the sensing TFT 130. Thus, an image switching channel region 123 included in the image switching TFT 120 and an output switching channel region 143 included in the output switching TFT 140 may be formed of a material incapable of absorbing IR light to prevent occurrence of malfunctions. Thus, the image switching channel region 123 and the output switching channel region 143 may be formed of a-Si, which does not absorb IR light. Furthermore, since a sensing channel region 133 included in the sensing TFT 130 should absorb IR light, the sensing channel region 133 may be formed of poly-Si.

In the above-described third exemplary embodiment, since the pixel electrode 260 is formed of a transparent conductive material, an additional through hole may not be required, so that a process of forming the through hole may be omitted.

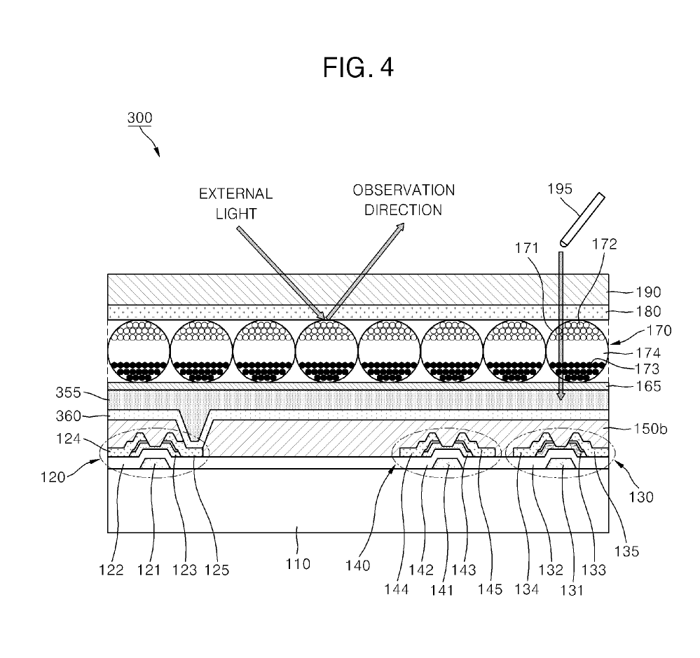

FIG. 4 is a schematic construction diagram of an electrophoretic display device according to a fourth exemplary embodiment of the present invention.

Referring to FIG. 4, an electrophoretic display device 300 according to a fourth exemplary embodiment may include a substrate 110, an image switching TFT 120, a sensing TFT 130, an output switching TFT 140, an insulating layer 150b, a pixel electrode 360, an IR filter 355, an adhesive 165, an electrophoretic film 170, a common electrode 180, and an upper plate 190.

An image switching channel region 123 may be formed on an image switching gate insulating layer 122, and be formed of a material incapable of absorbing IR light because the pixel electrode 360 to be described later is formed of a transparent material. For example, the image switching channel region 123 may be formed of a-Si. The image switching drain region 125 may be electrically connected to the pixel electrode 360 and switch an image signal voltage to the pixel electrode 360.

An output switching channel region 143 may be formed on an output switching gate insulating layer 142, and be formed of a material incapable of absorbing IR light because the pixel electrode 360 to be described later is formed of a transparent material. For example, the output switching channel region 143 may be formed of a-Si.

The pixel electrode 360 may be formed in a unit pixel region on the insulating layer 150b. Also, a contact hole exposing a portion of the image switching drain region 125 of the image switching TFT 120 may be formed in the insulating layer 150b. The pixel electrode 360 may extend into the contact hole and be electrically connected to the image switching drain region 125 of the image switching TFT 120. Thus, the image switching TFT 120 may switch a pixel voltage to the pixel electrode 360. As in the third exemplary embodiment, the pixel electrode 360 may be formed of a light transmitting material instead of a light blocking material. That is, the pixel electrode 360 may be formed of at least one selected from the group consisting of ITO, AZO, IZO, carbon nanotubes, and graphene. Since the pixel electrode 360 is formed of a transparent material, it is unnecessary to form an additional through hole in the pixel electrode 360 according to the fourth exemplary embodiment.

The IR filter 355 transmits only IR light without transmitting light having a wavelength other than an IR wavelength. The IR filter 355 may be formed as a single layer on the pixel electrode 360. The IR filter 355 may include a single thin layer formed of at least one material selected from the group consisting of chromium oxides (CrO and Cr₂O₃) and manganese oxides (MnO, Mn₃O₄, Mn₂O₃, MnO₂, and Mn₂O₇).

In the fourth exemplary embodiment, since the IR filter 355 includes the single thin layer, a forming process may be simplified more than when an IR filter includes a composite layer. Also, since the pixel electrode 360 is formed of a transparent conductive material, an additional through hole may not be required so that a process of forming the through hole may be omitted.

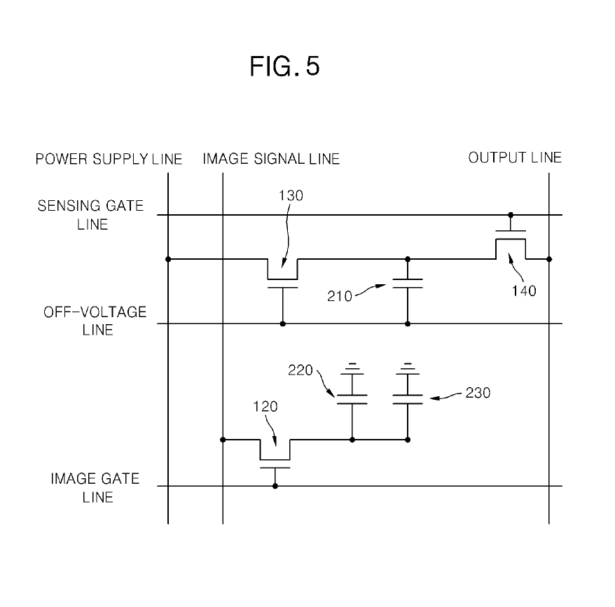

FIG. 5 is a circuit diagram of an image displaying process and a sensing process of an electrophoretic display device according to an exemplary embodiment of the present invention.

To begin with, an image displaying process of the electrophoretic display device 100a, 100b, 200, or 300 according to the present invention will be examined.

Referring to FIGS. 1 through 5, for a time period during which a pixel is selected, the image displaying process may include applying a voltage at which the channel region 123 of the image switching TFT 120 is turned on, to the image gate lines to turn on the channel region 123 of the image switching TFT 120 and simultaneously applying an image signal voltage to the image signal line to transmit the image signal voltage to the pixel electrode 160a, 160b, 260, or 360. For a time period during which no pixel is selected, the image displaying process may include applying a voltage at which the channel region 123 of the image switching TFT 120 is turned off, to the image gate line to turn off the channel region 123 of the image switching TFT 120 and simultaneously cut off the image signal voltage transmitted to the pixel electrode 160a, 160b, 260, or 360. Thus, pixels may be free from image information interference. A voltage may be switched to the pixel electrode 160a, 160b, 260, or 360 in the above-described manner so that an image may be displayed due to reflection of external light.

A capacitor 220 may correspond to a capacitor formed by the pixel electrode 160a, 160b, 260, or 360 and the common electrode 180. Also, a capacitor 230 may be a pixel-charge storage capacitor, which may prevent a voltage applied to a pixel from being changed due to a leakage current of the image switching TFT 120 for the time period during which no pixel is selected.

Next, a sensing process of the electrophoretic display device 100a, 100b, 200, or 300 according to the present invention will be examined.

Referring to FIGS. 1 through 5, to begin with, IR light may be incident to a specific region of the electrophoretic display device 100a, 100b, 200, or 300 using an IR pen 195 while maintaining the IR pen 195 out of contact with the electrophoretic display device 100a, 100b, 200, or 300. The incident IR light may be incident to the sensing TFT 130. In the case of the electrophoretic display device 100a according to the first exemplary embodiment, since the IR filter insulating layer 150a is formed between the through hole 163 and the sensing TFT 130, light having a wavelength other than an IR wavelength cannot be incident to the sensing TFT 130, thereby preventing occurrence of malfunctions in the sensing TFT 130. In the case of the electrophoretic display device 100b according to the second exemplary embodiment, IR light emitted from the IR pen 195 may pass through the through hole 163 and the IR filter 155 and be incident to the sensing TFT 130. In the case of the electrophoretic display device 200 according to the third exemplary embodiment, IR light emitted from the IR pen 195 may pass through the transparent pixel electrode 260 and the IR filter 255 and be incident to the sensing TFT 130. In the case of the electrophoretic display device 300 according to the fourth exemplary embodiment, IR light emitted from the IR pen 195 may pass through the IR filter 355 and the transparent pixel electrode 360 and be incident to the sensing TFT 130. In all of the second, third, and fourth exemplary embodiments, since IR light emitted from the IR pen 195 is incident to the sensing TFT 130 through the IR filters 155, 255, and 355, light having a wavelength other than an IR wavelength cannot be incident to the sensing TFT 130, thereby preventing occurrence of malfunctions in the sensing TFT 130.

When IR light is incident to the sensing TFT 130, the channel region 133 of the sensing TFT 130, which is formed of a material capable of absorbing IR light, may absorb IR light. Since the sensing gate electrode 131 of the sensing TFT 130 is connected to the off-voltage line, the channel region 133 may always be turned off without absorbing IR light.

However, when the channel region 133 of the sensing TFT 130 absorbs IR light, the channel region 133 may be partially turned on to increase a leakage current of the sensing TFT 130. When the leakage current of the sensing TFT 130 is increased, a storage capacitor 210 for storing an IR sensing signal may be charged with electrical charges. The charging of the storage capacitor 210 for storing the IR sensing signal may occur throughout a one-frame time.

During the charging of the storage capacitor 210 for storing the IR sensing signal, the off voltage at which the channel region 143 of the output switching TFT 140 is not turned on may be applied to the sensing gate line electrically connected to the output switching gate electrode 141 of the output switching TFT 140. However, in the time period during which a pixel is selected, an on voltage at which the channel region 143 of the output switching TFT 140 is turned on may be applied to the sensing gate line. Thus, the output switching TFT 140 may be switched so that electrical charges stored in the storage capacitor 210 for storing the IR sensing signal may flow along the output line. Thereafter, a position sensor (not shown) may read the amount of electrical charges and obtain position information regarding a position from which IR light is incident. Thus, the electrophoretic display device may perform a predetermined operation based on the position information.

According to the present invention, since a touch screen panel may be integrated in an electrophoretic display device, an increase in weight due to a touch screen may not be caused, and damage to the surface of the touch screen due to use of the touch screen over a long period may be prevented because the surface of the touch screen is not exposed. Furthermore, when the touch screen senses natural light in a visible light region, a rate of recognition may be reduced in dark places or in the shadow. However, the electrophoretic display device may sense IR light, and a high rate of recognition may be obtained without the limitation of locations or ambient brightness.

Furthermore, since an IR filter is formed of a single layer, a forming process may be simplified, and a pixel electrode may be formed of not only a metal but also a transparent conductive oxide (TCO), carbon nanotubes, or graphene.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

1. An electrophoretic display device comprising:
a substrate on which image gate lines and image signal lines are formed to intersect one another;
an image switching thin-film transistor (TFT) formed on the substrate and electrically connected to the image gate lines and the image signal lines;
a sensing TFT formed on the substrate and configured to sense infrared (IR) light and generate an IR sensing signal;
an output switching TFT formed on the substrate and connected to the sensing TFT, the output switching TFT configured to output position information from the IR sensing signal;
an IR filter insulating layer formed on the substrate to cover the sensing TFT and configured to transmit only the IR light;
a pixel electrode formed on the IR filter insulating layer and electrically connected to the image switching TFT;
an electrophoretic film formed on the pixel electrode and including a plurality of micro-capsules having pigment particles with positive and negative electrical charges; and
a common electrode formed on the electrophoretic film.

2. The display device of claim 1, wherein a through hole is formed through top and bottom surfaces of the pixel electrode and formed over the sensing TFT to allow incidence of IR light to the sensing TFT.

3. The display device of claim 2, wherein the pixel electrode is formed of a light reflective material to serve as a light blocking layer with respect to the image switching TFT and the output switching TFT.

4. The display device of claim 1, wherein the IR filter insulating layer includes first insulating layers and second insulating layers formed in an alternating fashion,
wherein the first insulating layers have a relatively high refractive index, and the second insulating layers have a relatively low refractive index.

5. The display device of claim 4, wherein the first insulating layers are formed of at least one selected from the group consisting of titanium oxide (TiO₂), tantalum oxide (Ta₂O₅), zirconium oxide (ZrO₂), and zinc sulfide (ZnS), and the second insulating layers are formed of at least one selected from the group consisting of silicon oxide (SiO₂), magnesium fluoride (MgF₂), and sodium aluminum iron (Na₃AlFe).

6. The display device of claim 1, wherein a channel region of the sensing TFT is formed of a material capable of absorbing light having an IR wavelength.

7. The display device of claim 6, wherein the channel region of the sensing TFT is formed of at least one selected from the group consisting of polycrystalline silicon (poly-Si), single crystalline Si, indium antimony (InSb), germanium (Ge), indium arsenide (InAs), indium gallium arsenide (InGaAs), cadmium telluride (CdTe), cadmium selenide (CdSe), gallium arsenide (GaAs), gallium indium phosphide (GaInP), indium phosphide (InP), and aluminum gallium arsenide (AlGaAs).

8. The display device of claim 6, wherein a channel region of each of the image switching TFT and the output switching TFT is formed of amorphous silicon (a-Si), and the channel region of the sensing TFT is formed of poly-Si.

9. An electrophoretic display device comprising:
a substrate on which image gate lines and image signal lines are formed to intersect one another;
an image switching thin-film transistor (TFT) formed on the substrate and electrically connected to the image gate lines and the image signal lines;
a sensing TFT formed on the substrate and configured to sense IR light and generate an IR sensing signal;
an output switching TFT formed on the substrate and connected to the sensing TFT, the output switching TFT configured to output position information from the IR sensing signal;
an insulating layer formed on the substrate to cover the image switching TFT, the sensing TFT, and the output switching TFT;
an IR filter formed as a single layer on the insulating layer and configured to transmit only the IR light;
a pixel electrode formed on the IR filter and electrically connected to the image switching TFT;
an electrophoretic film formed on the pixel electrode and including a plurality of micro-capsules having pigment particles with positive and negative electrical charges; and
a common electrode formed on the electrophoretic film.

10. An electrophoretic display device comprising:
a substrate on which image gate lines and image signal lines intersect one another;
an image switching TFT formed on the substrate and electrically connected to the image gate lines and the image signal lines;
a sensing TFT formed on the substrate and configured to sense IR light and generate an IR sensing signal;
an output switching TFT formed on the substrate and connected to the sensing TFT, the output switching TFT configured to output position information from the IR sensing signal;
an insulating layer formed on the substrate to cover the image switching TFT, the sensing TFT, and the output switching TFT;
a pixel electrode formed on the insulating layer and electrically connected to the image switching TFT;
an IR filter formed as a single layer on the pixel electrode and configured to transmit only the IR light;
an electrophoretic film formed on the IR filter and including a plurality of micro-capsules having pigment particles with positive and negative electrical charges; and
a common electrode formed on the electrophoretic film.

11. The display device of claim 9, wherein the IR filter is a single thin layer formed of at least one selected from the group consisting of chromium oxides (CrO and Cr₂O₃) and manganese oxides (MnO, Mn₃O₄, Mn₂O₃, MnO₂, and Mn₂O₇).

12. The display device of claim 9, wherein the pixel electrode is formed of a light reflective material to serve as a light blocking layer with respect to the image switching TFT and the output switching TFT,
and a through hole is formed through top and bottom surfaces of the pixel electrode and formed over the sensing TFT to allow incidence of the IR light to the sensing TFT.

13. The display device of claim 12, wherein a channel region of the sensing TFT is formed of at least one selected from the group consisting of poly-Si, single crystalline silicon, InSb, Ge, InAs, InGaAs, CdTe, CdSe, GaAs, GaInP, InP, and AlGaAs.

14. The display device of claim 9, wherein the pixel electrode is formed of a conductive material that transmits light, and
a channel region of each of the image switching TFT and the output switching TFT is formed of a-Si, and a channel region of the sensing TFT is formed of poly-Si.

15. The display device of claim 14, wherein the pixel electrode is formed of at least one selected from the group consisting of indium tin oxide (ITO), Al-doped zinc oxide (AZO), indium zinc oxide (IZO), carbon nanotubes, and graphene.

16. The display device of claim 1, wherein the common electrode is formed of a conductive material that transmits light.

17. The display device of claim 16, wherein the common electrode is formed of at least one selected from the group consisting of ITO, AZO, IZO, carbon nanotubes, and graphene.
